(19) United States
(12) Patent Application Publication
(10) Pub. No.: US 2023/0227346 A1
(43) Pub. Date: Jul. 20, 2023

(54) GLASS, STRENGTHENED GLASS, AND METHOD FOR MANUFACTURING STRENGTHENED GLASS

(71) Applicant: Nippon Electric Glass Co., Ltd., Shiga (JP)

(72) Inventors: Ryota SUZUKI, Shiga (JP); Ken YUKI, Shiga (JP)

(21) Appl. No.: 18/010,875

(22) PCT Filed: Jul. 6, 2021
(86) PCT No.: PCT/JP2021/025382

§ 371 Date: Dec. 16, 2022

(30) Foreign Application Priority Data
Jul. 8, 2020 (JP) 2020-117460

(51) Int. Cl. C03C 3/091; C03C 21/00

(52) U.S. Cl. CPC C03C 3/091; C03C 21/002; C03C 2201/32

(57) ABSTRACT

A glass of the present invention includes as a glass composition, in terms of mass %, 50% to 75% of SiO₂, 1% to 30% of Al₂O₃, 0% to 25% of B₂O₃, 0% to 10% of Li₂O, 0.01% to 20% of Na₂O, 0% to 10% of K₂O, 0.0001% to 0.1% of Fe₂O₃, 0.00001% to 0.01% of Cr, 0.00001% to 0.01% of Ni, and 0.0001% to 0.5% of TiO₂.

### TECHNICAL FIELD

The present invention relates to a glass, a tempered glass, and a method of manufacturing a tempered glass.

### BACKGROUND ART

A cover glass is used for protecting a display of a smartphone. In general, a tempered glass subjected to ion exchange treatment is used for the cover glass.

Currently, several hundred millions of smartphones are produced each year, and hence cover glasses corresponding thereto are required. Meanwhile, a large number of smartphones to be discarded are considered to occur. Accordingly, recycling of the cover glass is predicted to become urgent in the future.

### SUMMARY OF INVENTION

### Technical Problem

It is effective that a waste glass such as a cover glass, that is, a waste tempered glass be recycled into a cover glass by being loaded into a glass melting furnace again to be newly formed into a glass sheet.

However, when the waste tempered glass is melted again and then formed into a glass sheet, there are risks in that bubbles or foreign matter may be incorporated into the glass sheet, a desired glass composition may not be obtained, or a transmittance of the glass sheet may be reduced. In this case, the glass sheet may not be used for a cover glass for a smartphone.

In view of the above-mentioned circumstances, a technical object of the present invention is to devise a glass and a tempered glass to which a waste tempered glass is easily introduced as a glass raw material, and a method of manufacturing a tempered glass, to thereby reduce an environmental load through recycling of the waste tempered glass.

### Solution to Problem

The inventors of the present invention have made extensive investigations, and as a result, have found that the above-mentioned technical object can be achieved by strictly regulating the glass composition. Thus, the finding is proposed as the present invention. That is, according to one embodiment of the present invention, there is provided a glass, comprising as a glass composition, in terms of mass o, 50% to 75% of SiO₂, 1% to 30% of Al₂O₃, 0% to 25% of B₂O₃, 0% to 10% of Li₂O, 0.01% to 20% of Na₂O, 0% to 10% of K₂O, 0.0001% to 0.1% of Fe₂O₃, 0.00001% to 0.01% of Cr, 0.00001% to 0.01% of Ni, and 0.0001% to 0.5% of TiO₂.

In addition, it is preferred that the glass according to the one embodiment of the present invention comprise as the glass composition, in terms of mass %, 50% to 75% of SiO₂, 1% to 30% of Al₂O₃, 0% to 10% of B₂O₃, 0% to 10% of Li₂O, 3% to 20% of Na₂O, 0.001% to 10% of K₂O, 0% to 8% of ZrO₂, 0% to 10% of P₂O₅, 0.0001% to 0.1% of Fe₂O₃, 0.00001% to 0.01% of Cr, 0.00001% to 0.01% of Ni, and 0.0001% to 0.5% of TiO₂.

In addition, it is preferred that the glass according to the one embodiment of the present invention comprise as the glass composition, in terms of mass %, 60% to 75% of SiO₂, 1% to 15% of Al₂O₃, 1% to 25% of B₂O₃, 0% to 10% of Li₂O, 1% to 15% of Na₂O, 0.001% to 5% of K₂O, 0% to 10% of CaO, 0% to 5% of BaO, 0% to 5% of ZnO, 0.0001% to 0.1% of Fe₂O₃, 0.00001% to 0.01% of Cr, 0.00001% to 0.01% of Ni, and 0.0001% to 0.1% of TiO₂.

In addition, it is preferred that the glass according to the one embodiment of the present invention comprise as the glass composition, in terms of mass %, 65% to 75% of SiO₂, 5% to 15% of Al₂O₃, 1% to 15% of B₂O₃, 0% to 5% of Li₂O, 1% to 15% of Na₂O, 0.001% to 5% of K₂O, 0% to 10% of CaO, 0% to 5% of BaO, 0.0001% to 0.1% of Fe₂O₃, 0.00001% to 0.01% of Cr, 0.00001% to 0.01% of Ni, and 0.0001% to 0.1% of TiO₂.

In addition, it is preferred that the glass according to the one embodiment of the present invention have a content of SnO₂ of from 0 mass % to 3.0 mass % in the glass composition.

In addition, it is preferred that the glass according to the one embodiment of the present invention have a content of Cl of from 0.001 mass % to 0.3 mass % in the glass composition.

In addition, it is preferred that the glass according to the one embodiment of the present invention have a content of SO₃ of from 0 mass % to 0.3 mass % in the glass composition.

In addition, it is preferred that the glass according to the one embodiment of the present invention have a shape selected from the group consisting of a sheet shape, a tube shape, and a rod shape.

In addition, it is preferred that the glass according to the one embodiment of the present invention have an external transmittance at a wavelength of 550 nm and a thickness of 0.55 mm of 90% or more.

In addition, it is preferred that the glass according to the one embodiment of the present invention have an external transmittance at a wavelength of 400 nm and a thickness of 0.55 mm of 85% or more.

In addition, it is preferred that the glass according to the one embodiment of the present invention have a chromaticity (X,Y) in xy chromaticity coordinates (C light source, sheet thickness 1 mm conversion) within a range of (0.3090 to 0.3120, 0.3150 to 0.3180).

In addition, it is preferred that the glass according to the one embodiment of the present invention be used for any one of a window glass for a vehicle, a cover glass of an interior panel for a vehicle, a cover glass for a CMOS sensor package, a cover glass for a LED package, a cover glass for a wireless communication device, a glass for a pharmaceutical container, a glass for a laboratory device, or a glass for supporting a semiconductor.

According to one embodiment of the present invention, there is provided a tempered glass, comprising a compressive stress layer on a surface thereof, and it is preferred that the tempered glass comprise the above-mentioned glass.

In addition, it is preferred that the tempered glass according to the one embodiment of the present invention have a compressive stress value of from 200 MPa to 1,500 MPa on an outermost surface thereof.

In the tempered glass according to the one embodiment of the present invention, it is preferred that the compressive stress layer have a depth of layer of from 5 μm to 100 μm.

According to one embodiment of the present invention, there is provided a method of manufacturing a tempered glass, comprising melting and forming a glass batch containing a waste tempered glass to provide a glass, and then subjecting the glass to ion exchange treatment to provide a tempered glass. The “waste tempered glass” refers to a waste glass including a glass having a compressive stress layer on a surface thereof.

The waste tempered glass has a compressive stress layer on a surface thereof, and hence at the time of breakage, there are risks in that a human body may be injured or broken pieces may fly into an eye. Accordingly, the waste tempered glass is not easily crushed into a shape that is easily loaded into a glass melting furnace. In view of the above-mentioned circumstances, an attempt to recycle the waste tempered glass has not been positively investigated until recently. However, in response to an increasing necessity for recycling of the cover glass, the method of manufacturing a tempered glass according to the one embodiment of the present invention comprises using a waste tempered glass as a glass raw material.

In the method of manufacturing a tempered glass according to the one embodiment of the present invention, it is preferred that a ratio of the waste tempered glass in the glass batch be from 0.1 mass % to 100 mass %.

In the method of manufacturing a tempered glass according to the one embodiment of the present invention, it is preferred that the waste tempered glass comprise, as a glass composition, in terms of mass %, 50% to 75% of SiO₂, 1% to 30% of Al₂O₃, 0% to 25% of B₂O₃, 0% to 10% of Li₂O, 0.01% to 20% of Na₂O, 0% to 10% of K₂O, 0% to 0.3% of Cl, and 0% to 0.3% of SO₃.

In the method of manufacturing a tempered glass according to the one embodiment of the present invention, it is preferred that the waste tempered glass have a particle size D₅₀ of from 1 μm to 100 μm.

It is preferred that the method of manufacturing a tempered glass according to the one embodiment of the present invention further comprise adding, as a glass raw material, one kind or two or more kinds selected from the group consisting of an alkali metal sulfate, an alkali metal chloride, stannic oxide, and antimony trioxide into the glass batch.

It is preferred that the method of manufacturing a tempered glass according to the one embodiment of the present invention further comprise adding, as a glass raw material, a nitrate raw material into the glass batch.

In the method of manufacturing a tempered glass according to the one embodiment of the present invention, it is preferred that a cation of the nitrate raw material be an alkali metal ion or an alkaline earth metal ion. It is preferred that the alkali metal ion be one kind or two or more kinds selected from the group consisting of a lithium ion, a sodium ion, and a potassium ion. It is preferred that the alkaline earth metal ion be a strontium ion and/or a barium ion.

### DESCRIPTION OF EMBODIMENTS

A glass (tempered glass) of the present invention comprises as a glass composition, in terms of mass %, about 50% to about 75% of SiO₂, about 1% to about 30% of Al₂O₃, about 0% to about 25% of B₂O₃, about 0% to about 10% of Li₂O, about 0.01% to about 20% of Na₂O, about 0% to about 10% of K₂O, about 0.0001% to about 0.1% of Fe₂O₃, about 0.00001% to about 0.01% of Cr, about 0.00001% to about 0.01% of Ni, and about 0.0001% to about 0.5% of TiO₂. Herein, the reason why the content of each component is limited is described below. In the following description of each component, the expression “%” means “mass %”. In addition, the expression “A%” described below means “about A%”. For example, “5%” means “about 5%”.

SiO₂ is a component that forms a glass network. When the content of SiO₂ is too small, vitrification does not occur easily, and a thermal expansion coefficient becomes too high, with the result that thermal shock resistance is liable to be reduced. Accordingly, a suitable lower limit of the content range of SiO₂ is 50% or more, 52% or more, 55% or more, 57% or more, 59% or more, 60% or more, or 63% or more, particularly 65% or more. Meanwhile, when the content of SiO₂ is too large, meltability and formability are liable to be reduced, and the thermal expansion coefficient is excessively reduced, with the result that it becomes difficult to match the thermal expansion coefficient with those of peripheral materials. Accordingly, a suitable upper limit of the content range of SiO₂ is 75% or more, 73% or less, 71% or less, 70% or less, 68% or less, or 66% or less, particularly 65% or less.

Al₂O₃ is a component that improves ion exchange performance, and is also a component that increases a strain point, a Young's modulus, fracture toughness, and a Vickers hardness. Accordingly, a suitable lower limit of the content range of Al₂O₃ is 1% or more, 2% or more, 3% or more, 4% or more, 5% or more, 6% or more, 7% or more, 8% or more, 9% or more, 10% or more, 12% or more, 13% or more, 14% or more, or 14.4% or more, particularly 15% or more. Meanwhile, when the content of Al₂O₃ is too large, a viscosity at high temperature is increased, with the result that the meltability and the formability are liable to be reduced. In addition, a devitrified crystal is liable to precipitate in the glass, and it becomes difficult to form the glass into a sheet shape by an overflow down-draw method or the like. Particularly when a glass sheet is formed by an overflow down-draw method involving using alumina-based refractory as forming body refractory, a devitrified crystal of spinel is liable to precipitate at an interface with the alumina-based refractory. Further, acid resistance is reduced, with the result that it becomes difficult to apply the glass to an acid treatment step. Accordingly, a suitable upper limit of the content range of Al₂O₃ is 30% or less, 29% or less, 28% or less, 27% or less, 26% or less, 25% or less, 21% or less, 20.5% or less, 20% or less, 18% or less, 17% or less, or 16% or less, particularly 15% or less.

B₂O₃ is a component that reduces the viscosity at high temperature and a density, and stabilizes the glass to cause less precipitation of a crystal, to thereby reduce a liquidus temperature. When the content of B₂O₃ is too small, a depth of layer at the time of ion exchange between a Li ion in the glass and a Na ion in a molten salt becomes excessively large, and as a result, a compressive stress value of a compressive stress layer on an outermost surface is liable to be small. In addition, there is a risk in that the glass may be unstable, and devitrification resistance may be reduced. Accordingly, a suitable lower limit of the content range of B₂O₃ is 0% or more, 0.1% or more, 0.2% or more, 0.3% or more, 0.4% or more, 0.5% or more, 0.6% or more, 0.7% or more, 0.8% or more, or 0.9% or more, particularly 1% or more. Meanwhile, when the content of B₂O₃ is too large, there is a risk in that the depth of layer may be reduced. In particular, efficiency of ion exchange between a Na ion in the glass and a K ion in the molten salt is liable to be reduced, and the depth of layer of the compressive stress layer is liable to be reduced. Accordingly, a suitable upper limit of the content range of B₂O₃ is 25% or less, 10% or less, 8% or less, 7% or less, 6% or less, 5% or less, 4% or less, 3.8% or less, 3.5% or less, 3.3% or less, 3.2% or less, 3.1% or less, 3% or less, 2.9% or less, 2.7% or less, 2.5% or less, 2.3% or less, 2.1% or less, or 1.9% or less, particularly 1.7% or less.

Li₂O is an ion exchange component, and is particularly an essential component for obtaining a large depth of layer through ion exchange between a Li ion in the glass and a Na ion in the molten salt. In addition, Li₂O is a component that reduces the viscosity at high temperature to improve the meltability and the formability, and is also a component that increases the Young's modulus. Accordingly, a suitable lower limit of the content range of Li₂O is 0% or more, 0.001% or more, 0.003% or more, 0.004% or more, 0.005% or more, 0.006% or more, or 0.007% or more, particularly 0.008% or more. Accordingly, a suitable upper limit of the content range of Li₂O is 10% or less, 9.9% or less, 9% or less, 8.9% or less, 8% or less, 7.5% or less, 6.5% or less, 5% or less, 4.5% or less, 3.5% or less, 2.5% or less, 1.4% or less, 1% or less, 0.8% or less, 0.6% or less, or 0.4% or less, particularly 0.2% or less.

Na₂O is an ion exchange component, and is also a component that reduces the viscosity at high temperature to improve the meltability and the formability. In addition, Na₂O is a component that improves the devitrification resistance, and is particularly a component that suppresses devitrification caused by a reaction with alumina-based refractory. Accordingly, a suitable lower limit of the content range of Na₂O is 0.01% or more, 4% or more, 5% or more, 6% or more, 7% or more, 8% or more, 9% or more, 10% or more, 10.6% or more, 11.4% or more, 12.5% or more, 12.6% or more, 12.7% or more, 12.8% or more, 12.9% or more, 13.0% or more, or 13.2% or more, particularly 13.5% or more. Meanwhile, when the content of Na₂O is too large, the thermal expansion coefficient is excessively increased, and the thermal shock resistance is liable to be reduced. In addition, the glass composition loses its component balance, and the devitrification resistance may be reduced contrarily. Accordingly, a suitable upper limit of the content range of Na₂O is 20% or less, 19.5% or less, 19% or less, 18% or less, 17% or less, 16% or less, 15% or less, 14.9% or less, 14.8% or less, or 14.7% or less, particularly 14.6% or less.

K₂O is a component that reduces the viscosity at high temperature to improve the meltability and the formability. However, when the content of K₂O is too large, the thermal expansion coefficient is excessively increased, and the thermal shock resistance is liable to be reduced. In addition, the compressive stress value of the compressive stress layer on the outermost surface is liable to be reduced. Accordingly, a suitable upper limit of the content range of K₂O is 10% or less, 7% or less, 6% or less, 5% or less, 4% or less, 3.5% or less, 3% or less, 2.5% or less, 2.3% or less, 2.1% or less, or 2.0% or less, particularly less than 1.9%. When the viewpoint of increasing the depth of layer is emphasized, a suitable lower limit of the content range of K₂O is 0% or more, 0.001% or more, 0.002% or more, 0.003% or more, 0.005% or more, 0.007% or more, 0.1% or more, 0.15% or more, 0.2% or more, 0.22% or more, 0.3% or more, or 0.5% or more, particularly 1.0% or more.

An alkali metal oxide is an ion exchange component, and is a component that reduces the viscosity at high temperature to improve the meltability and the formability. When the content of the alkali metal oxide (Li₂O+Na₂O+K₂O) is too large, there is a risk in that the thermal expansion coefficient may be increased. In addition, there is a risk in that the acid resistance may be reduced. Accordingly, a suitable lower limit of the content range of the alkali metal oxide is 4% or more, 7% or more, 10% or more, 11% or more, 12% or more, 13% or more, or 14% or more, particularly 15% or more, and a suitable upper limit of the content range thereof is 25% or less, 23% or less, 20% or less, or 19% or less, particularly 18% or less.

Fe₂O₃ is a component that absorbs visible light, and when the content thereof becomes large, a visible light transmittance is liable to be reduced. Meanwhile, when the content of Fe₂O₃ is small, it becomes difficult to use a waste tempered glass, and recycling efficiency is liable to be reduced. A suitable content of Fe₂O₃ is from 0.0001% to 0.1% or from 0.0005% to 0.02%, particularly from 0.001% to 0.015%.

Cr is a component that absorbs visible light, and when the content thereof becomes large, the visible light transmittance is liable to be reduced. Meanwhile, when the content of Cr is small, it becomes difficult to use the waste tempered glass, and the recycling efficiency is liable to be reduced. Accordingly, a suitable lower limit of the content of Cr is 0.00001% or more, 0.00002% or more, 0.00003% or more, or 0.00004% or more, particularly 0.00005% or more, and a suitable upper limit of the content range thereof is 0.01% or less, 0.009% or less, 0.005% or less, 0.001% or less, 0.0009% or less, 0.0005% or less, 0.0004 or less, 0.0003 or less, 0.0002 or less, or 0.0001% or less, particularly 0.00009% or less.

Ni is a component that absorbs visible light, and when the content thereof becomes large, the visible light transmittance is liable to be reduced. Meanwhile, when the content of Ni is small, it becomes difficult to use the waste tempered glass, and the recycling efficiency is liable to be reduced. Accordingly, a suitable lower limit of the content of Ni is 0.00001% or more, 0.00002% or more, 0.00003% or more, or 0.00004% or more, particularly 0.00005% or more, and a suitable upper limit of the content range thereof is 0.01% or less, 0.009% or less, 0.005% or less, 0.001% or less, 0.0009% or less, 0.0005% or less, 0.0004 or less, 0.0003 or less, 0.0002 or less, or 0.0001% or less, particularly 0.00009% or less.

TiO₂ is a component that absorbs visible light, and when the content thereof becomes large, the visible light transmittance is liable to be reduced. Meanwhile, when the content of TiO₂ is small, it becomes difficult to use the waste tempered glass, and the recycling efficiency is liable to be reduced. Accordingly, a suitable lower limit of the content of TiO₂ is 0.0001% or more, 0.0002% or more, 0.0003% or more, 0.0004% or more, or 0.0005% or more, particularly 0.001% or more, and a suitable upper limit of the content range thereof is 0.5% or less, 0.4% or less, 0.3% or less, 0.2% or less, 0.1% or less, 0.09% or less, 0.05% or less, 0.01% or less, 0.009% or less, 0.005% or less, or 0.004% or less, particularly 0.003% or less.

For example, the following components other than the above-mentioned components may be added.

MgO is a component that reduces the viscosity at high temperature to improve the meltability and the formability, and increases the strain point and the Vickers hardness. Among alkaline earth metal oxides, MgO is a component that has a high effect of improving the ion exchange performance. However, when the content of MgO is too large, the devitrification resistance is liable to be reduced, and in particular, it becomes difficult to suppress devitrification caused by a reaction with alumina-based refractory. Accordingly, a suitable content of MgO is from 0% to 10%, from 0% to 4.9%, from 0.1% to 4%, or from 0.2% to 3.3%, particularly from 0.5% to less than 3%.

CaO is a component that reduces the viscosity at high temperature to improve the meltability and the formability and increase the strain point and the Vickers hardness without reducing the devitrification resistance as compared to other components. However, when the content of CaO is too large, there is a risk in that the ion exchange performance may be reduced, or an ion exchange solution may be degraded at the time of ion exchange treatment. Accordingly, a suitable upper limit of the content range of CaO is 10% or less, 6% or less, 5% or less, 4% or less, 3.5% or less, 3% or less, 2% or less, 1% or less, less than 1%, 0.5% or less, or 0.3% or less, particularly less than 0.1%.

SrO and Ba0 are each a component that reduces the viscosity at high temperature to improve the meltability and the formability and increase the strain point and the Young's modulus. However, when the contents of SrO and Ba0 are too large, an ion exchange reaction is liable to be inhibited. Besides, the density or the thermal expansion coefficient is increased inappropriately, or the glass is liable to devitrify. Accordingly, suitable contents of SrO and Ba0 are each from 0% to 5%, from 0% to 2%, from 0% to 1.5%, from 0% to 1%, from 0% to 0.5%, or from 0% to 0.1%, particularly from 0% to less than 0.1%.

ZnO is a component that reduces the viscosity at high temperature to improve the meltability and the formability. However, when the content of ZnO is too large, the glass is liable to devitrify. Accordingly, a suitable content of ZnO is from 0% to 5%, from 0% to 2%, from 0% to 1.5%, from 0% to 1%, from 0% to 0.5%, or from 0% to 0.1%, particularly from 0% to less than 0.1%.

ZrO₂ is a component that increases the Vickers hardness, and is also a component that increases viscosity around the liquidus viscosity and the strain point. However, when the content of ZrO₂ is too large, there is a risk in that the devitrification resistance is remarkably reduced. Accordingly, a suitable content of ZrO₂ is from 0% to 8%, from 0% to 4%, from 0% to 2%, from 0% to 1.8%, from 0.001% to 1.5%, from 0.002% to 1%, or from 0.003% to 0.1%, particularly from 0.010% to 0.050%.

P₂O₅ is a component that improves the ion exchange performance, and is particularly a component that increases the depth of layer. Further, P₂O₅ is a component that improves the acid resistance as well. When the content of P₂O₅ is too small, there is a risk in that the ion exchange performance cannot be sufficiently exhibited. In particular, the efficiency of ion exchange between a Na ion in the glass and a K ion in the molten salt is liable to be reduced, and the depth of layer of the compressive stress layer is liable to be reduced. In addition, there is a risk in that the glass may be unstable, and the devitrification resistance may be reduced. Accordingly, a suitable lower limit of the content range of P₂O₅ is 0% or more, 0.1% or more, 0.4% or more, 0.7% or more, 1% or more, 1.2% or more, 1.4% or more, 1.6% or more, 2% or more, 2.3% or more, or 2.5% or more, particularly 3% or more. Meanwhile, when the content of P₂O₅ is too large, the glass is liable to undergo phase separation, or water resistance is liable to be reduced. Accordingly, a suitable upper limit of the content range of P₂O₅ is 10% or less, 5% or less, 4.5% or less, 4% or less, 3% or less, 2% or less, or 1% or less, particularly 0.4% or less.

An oxide, such as Nd₂O₃, La₂O₃, Y₂O₃, Nb₂O₅, Ta₂O₅, or Hf₂G₃, is a component that increases the Young's modulus. However, costs of raw materials therefor are high. In addition, when the oxide is added in a large amount, the devitrification resistance is liable to be reduced. Accordingly, suitable contents of the oxides are each 5% or less, 3% or less, 2% or less, 1% or less, or 0.5% or less, particularly 0.1% or less.

SnO₂ is a component that improves a fining property of the glass, and is also a component that improves the ion exchange performance. However, when the content of SnO₂ is too large, the devitrification resistance is liable to be reduced. Accordingly, a suitable lower limit of the content range of SnO₂ is 0% or more, 0.01% or more, 0.05% or more, 0.07% or more, or 0.09% or more, particularly 0.1% or more, and a suitable upper limit of the content range thereof is 3.0% or less, 2.0% or less, 1.0% or less, 0.9% or less, 0.8% or less, or 0.6% or less, particularly 0.5% or less.

Cl is a fining agent, but is a component that adversely affects an environment or a facility when the content thereof is too large. Accordingly, a suitable lower limit of the content range of Cl is 0.001% or more, particularly 0.01% or more, and a suitable upper limit thereof is 0.3% or less or 0.2% or less, particularly 0.1% or less.

SO₃ is a fining agent, but is a component that adversely affects an environment or a facility when the content thereof is too large. Accordingly, a suitable lower limit of the content range of SO₃ is 0% or more or 0.001% or more, particularly 0.01% or more, and a suitable upper limit thereof is 0.3% or less, 0.25% or less, 0.2% or less, 0.15% or less, 0.1% or less, or 0.07% or less, particularly 0.05% or less.

It is preferred that the glass (tempered glass) of the present invention be substantially free of As₂O₃, Sb₂O₃, PbO, and F as a glass composition from the standpoint of environmental considerations. In addition, it is also preferred that the glass be substantially free of Bi₂O₃ from the standpoint of environmental considerations. The “substantially free of” has a concept in which the explicit component is not positively added as a glass component, but its addition at an impurity level is permitted, and specifically refers to the case in which the content of the explicit component is less than 0.05%.

A shape of the glass of the present invention is not limited. Of those, a sheet shape, a tube shape, or a rod shape is preferred as the shape, and a rectangular sheet, a disc, a cylindrical tube, a rectangular tube, a hollow tube, a solid rod, or the like is particularly preferred.

When the glass has a sheet shape, a sheet thickness thereof is preferably 0.01 mm or more, 0.02 mm or more, 0.03 mm or more, 0.05 mm or more, 0.07 mm or more, 0.1 mm or more, or 0.2 mm or more, particularly preferably 0.3 mm or more, and is preferably 1.0 mm or less, 0.8 mm or less, or 0.7 mm or less, particularly preferably 0.6 mm or less. When the sheet thickness falls outside the above-mentioned ranges, it is difficult to use the glass for a cover glass for a smartphone.

When the glass is a cylindrical tube, a thickness thereof is preferably 0.1 mm or more or 0.2 mm or more, particularly preferably 0.3 mm or more, and is preferably 1.0 mm or less or 0.8 mm or less, particularly preferably 0.7 mm or less. A lower limit value of an outer diameter thereof is preferably 1 mm or more, 2 mm or more, 3 mm or more, 4 mm or more, 5 mm or more, 6 mm or more, 7 mm or more, 8 mm or more, or 9 mm or more, particularly preferably 10 mm or more, and is preferably 50 mm or less, 45 mm or less, 40 mm or less, or 35 mm or less, particularly preferably 30 mm or less. When the thickness or the outer diameter falls outside the above-mentioned ranges, it is difficult to use the glass for a pharmaceutical container.

An external transmittance at a wavelength of 550 nm and a thickness of 0.55 mm is preferably 90% or more, 90.1% or more, or 90.3% or more, particularly preferably 90.5% or more. The external transmittance at a wavelength of 400 nm and a thickness of 0.55 mm is preferably 85% or more, 86% or more, or 87% or more, particularly preferably 88% or more. When the external transmittance is too low, visibility of a display is liable to be reduced when the glass is used for a cover glass for a smartphone.

In the glass (tempered glass) of the present invention, “x” in xy chromaticity coordinates (C light source, sheet thickness 1 mm conversion) is preferably from 0.3090 to 0.3120, from 0.3095 to 0.3115, from 0.3097 to 0.3110, or from 0.3098 to 0.3107, particularly preferably from 0.3100 to 0.3107. With this configuration, a tinge becomes small, and hence when the glass is used in an exterior part having a configuration in which part or entirety of an end surface is exposed to the outside, luxurious feeling can be produced.

“y” in the xy chromaticity coordinates (C light source, sheet thickness 1 mm conversion) is preferably from 0.3150 to 0.3180, from 0.3155 to 0.3175, or from 0.3160 to 0.3170, particularly preferably from 0.3161 to 0.3167. With this configuration, a tinge becomes small, and hence when the glass is used in an exterior part having a configuration in which part or entirety of an end surface is exposed to the outside, luxurious feeling can be produced.

When the glass of the present invention is subjected to ion exchange treatment, a tempered glass having a compressive stress layer on a surface thereof can be obtained.

The compressive stress value on the outermost surface is preferably 200 MPa or more, 220 MPa or more, 250 MPa or more, 280 MPa or more, 300 MPa or more, or 310 MPa or more, particularly preferably 320 MPa or more. When the compressive stress value on the outermost surface becomes higher, the Vickers hardness is increased more. Meanwhile, when an excessively large compressive stress is formed in the surface, an internal tensile stress of the glass sheet is increased excessively, and there is a risk in that a dimensional change before and after ion exchange treatment may be increased. Accordingly, the compressive stress value on the outermost surface is preferably 1,500 MPa or less, 1,400 MPa or less, 1,300 MPa or less, or 1,200 MPa or less, particularly preferably 1,100 MPa or less. There is a tendency that the compressive stress value on the outermost surface is increased when an ion exchange time period is shortened, or the temperature of an ion exchange solution is reduced.

The depth of layer is preferably 5 μm or more, 10 μm or more, 20 μm or more, or 30 μm or more, particularly preferably 40 μm or more. As the depth of layer becomes larger, protrusions on the ground are less liable to reach a tensile stress layer of the glass sheet at the time of dropping of the glass sheet, and thus the breakage probability of the glass sheet can be reduced more. Meanwhile, when the depth of layer is too large, there is a risk in that a dimensional change before and after the ion exchange treatment may be increased. Further, there is a tendency that the compressive stress value on the outermost surface is reduced. Accordingly, the depth of layer is preferably 100 μm or less, 80 μm or less, or 60 μm or less, particularly preferably 55 μm or less. There is a tendency that the depth of layer is increased when the ion exchange time period is prolonged, or the temperature of the ion exchange solution is increased.

A method of manufacturing a tempered glass of the present invention comprises melting and forming a glass batch containing a waste tempered glass to provide a glass, and then subjecting the glass to ion exchange treatment to provide a tempered glass. Herein, the waste tempered glass is preferably a waste tempered glass obtained by recovering a commercially available cover glass for a smartphone or glass for a pharmaceutical container.

The ratio of the waste tempered glass in the glass batch is, in terms of mass %, preferably less than 100.0%, 99.9% or less, 99% or less, 95% or less, 90% or less, 85% or less, 80% or less, less than 80%, 75% or less, 70% or less, 65% or less, or 60% or less, particularly preferably 55% or less. When the ratio of the waste tempered glass is too large, it becomes difficult to obtain desired glass composition and desired stress characteristics. In addition, due to the influence of an impurity (e.g., Fe₂O₃, Cr, Ni, or TiO₂) incorporated in, for example, a step of pulverizing or conveying the waste tempered glass, it becomes difficult to obtain a desired transmittance or desired chromaticity characteristics. Meanwhile, the ratio of the waste tempered glass is, in terms of mass %, 0.1% or more, 0.3% or more, 0.5% or more, 1% or more, 3% or more, 5% or more, 10% or more, 20% or more, or 30% or more, particularly 40% or more. When the ratio of the waste tempered glass is too small, a usage amount of the waste tempered glass becomes small, and hence recycling of the waste glass is not promoted. In addition, solubility of the glass batch is reduced, with the result that productivity of the glass sheet is liable to be reduced.

The waste tempered glass preferably comprises as a glass composition, in terms of mass %, 50% to 75% of SiO₂, 1% to 30% of A1₂0₃, 0% to 25% of B₂O₃, 0% to 10% of Li₂O, 0.01% to 20% of Na₂O, 0% to 10% of K₂O, 0% to 0.3% of Cl, and 0% to 0.3% of SO₃, and preferably further comprises 0.0001% to 0.1% of Fe₂O₃, 0.00001% to 0.01% of Cr, 0.00001% to 0.01% of Ni, and 0.0001% to 0.5% of TiO₂ as minor components. When the amount of the minor component is too large, a transmittance and color tone of a tempered glass produced using the waste tempered glass may be changed, and hence necessity for using a raw material having a small amount of the minor component increases, with the result that there is a risk in that the manufacturing cost may rise. In addition, when the amount of the minor component is too small, differences in transmittance and color tone between the tempered glass and a tempered glass that is already commercially available increase. In order to adjust the differences, the minor component needs to be added to the glass batch, with the result that there is a risk in that the manufacturing cost may rise.

An upper limit of an average particle diameter D₅₀ of the waste tempered glass is preferably 100 μm or less, 80 μm or less, 60 μm or less, 50 μm or less, or 40 μm or less, particularly preferably 35 μm or less. When the average particle diameter D₅₀ of the waste tempered glass is too large, solubility of the glass batch is reduced. In addition, separation of the glass batch is liable to occur, and hence uniformity of the glass composition of the molten glass is liable to be reduced.

Meanwhile, the upper limit of the average particle diameter D₅₀ of the waste tempered glass is preferably 1 μm or more, 2 μm or more, 3 μm or more, 4 μm or more, 5 μm or more, or 10 μm or more, particularly preferably 15 μm or more. When the average particle diameter D₅₀ of the waste tempered glass is too small, there is a risk in that dust of the waste tempered glass may rise to fluctuate the composition of the glass batch. Herein, the “average particle diameter D₅₀” refers to a numerical value called a median diameter in general, which may be measured with, for example, a laser diffraction particle size distribution analyzer SALD-2200 manufactured by Shimadzu Corporation. In the case of a large size that is difficult to measure with the laser diffraction particle size distribution analyzer, the average particle diameter D₅₀ of the waste tempered glass may be measured by using a known mesh sieve.

In the method of manufacturing a tempered glass of the present invention, it is particularly preferred that the glass composition of the waste tempered glass (specifically, waste tempered glass after pulverization) be analyzed, and then a required amount of the waste tempered glass be added to the glass batch, followed by melting. In this way, an amount of a component having an influence on a transmittance or a chromaticity, such as Fe₂O₃, Cr, Ni, or TiO₂, can be easily controlled.

In the method of manufacturing a tempered glass of the present invention, in addition to the waste tempered glass, as a glass raw material, an alkali metal sulfate, an alkali metal chloride, stannic oxide, or antimony trioxide is preferably added. Those components may each serve as a fining agent. The fining agent in the waste tempered glass has already lost a fining action in many cases. Accordingly, when the waste tempered glass is melted again, a glass sheet free of bubbles can be manufactured again by newly adding a fining agent.

In the method of manufacturing a tempered glass of the present invention, a nitrate is preferably used as a part of the glass raw material. A nitric acid ion serves as an ion that oxidizes another metal ion in the molten glass. Thus, an oxidation number of the metal ion of the impurity in the glass can be controlled. As a result, the transmittance or chromaticity of the glass can be controlled.

A cation of the nitrate is preferably an alkali metal ion or an alkaline earth metal ion. A cation of an alkali metal nitrate is preferably a lithium ion, a sodium ion, or a potassium ion. In this case, lithium nitrate, sodium nitrate, or potassium nitrate may be used as a glass raw material. A cation of an alkaline earth metal nitrate is preferably a strontium ion or a barium ion. In this case, strontium nitrate or barium nitrate may be used as a glass raw material.

In the method of manufacturing a tempered glass of the present invention, a carbonate is preferably used as a part of the glass raw material. Thus, cost reduction of the glass batch can be achieved. A cation of the carbonate is preferably an alkali metal ion or an alkaline earth metal ion. A cation of an alkali metal carbonate is preferably a lithium ion, a sodium ion, or a potassium ion. In this case, lithium carbonate, sodium carbonate, or potassium carbonate may be used as a glass raw material. A cation of an alkaline earth metal carbonate is preferably a calcium ion, a strontium ion, or a barium ion. In this case, calcium carbonate, strontium carbonate, or barium carbonate may be used as a glass raw material.

In the method of manufacturing a tempered glass of the present invention, an oxide raw material is preferably used as a part of the glass raw material. The oxide raw material is free from generating a gas such as carbon dioxide at the time of melting, and hence can reduce an environmental load at the time of melting. One kind or two or more kinds selected from, for example, lithium oxide, sodium oxide, potassium oxide, calcium oxide, strontium oxide, and barium oxide are preferably used as the oxide raw material.

In the method of manufacturing a glass that can be chemically tempered of the present invention, an upper limit of a mass ratio (content of oxide raw material in glass batch)/(total amount of oxide raw material and carbonate raw material in glass batch) is preferably 1 or less, 0.9 or less, 0.8 or less, or 0.7 or less, particularly preferably 0.6 or less, and a lower limit thereof is preferably 0.01 or more, 0.05 or more, 0.1 or more, 0.2 or more, or 0.25 or more, particularly preferably 0.3 or more. When the ratio is too low, it is difficult to reduce an environmental load. Meanwhile, when the ratio is too high, the cost of the glass batch is liable to rise.

As a method of forming the molten glass, various forming methods may be adopted. As a method of forming the molten glass into a sheet shape, an overflow down-draw method is preferably adopted. The overflow down-draw method is a method by which a high-quality glass sheet can be manufactured in a large amount and a large-sized glass sheet can also be easily manufactured. Further, in the overflow down-draw method, alumina or zirconia is used as forming body refractory. However, the glass of the present invention has good compatibility with alumina or zirconia, particularly alumina, and hence is less liable to generate bubbles, stones, or the like through a reaction with those forming bodies.

The tempered glass of the present invention is manufactured by subjecting a glass to ion exchange treatment. The condition of the ion exchange treatment is not particularly limited, and an optimum condition may be selected in consideration of, for example, viscosity characteristics, a usage, a thickness, an internal tensile stress, or a dimensional change of the glass. In particular, when a K ion in a KNO₃ molten salt is subjected to ion exchange with a Na component in the glass, the compressive stress layer on a surface thereof can be effectively formed.

The number of times of the ion exchange treatment is not particularly limited, and the ion exchange treatment may be performed only once or a plurality of times. When the ion exchange treatment is performed a plurality of times, it is preferred that the ion exchange treatment be performed twice. Thus, the total amount of the tensile stress accumulated in the inside of the glass can be reduced while the depth of layer is increased.

As described above, the method of manufacturing a tempered glass of the present invention comprises melting and forming the glass batch containing a waste tempered glass to provide a glass, but a waste glass formed of a glass that can be subjected to ion exchange is also preferably used instead of the waste tempered glass. Herein, the waste glass formed of the glass that can be subjected to ion exchange is preferably a waste glass generated at the time of forming, processing, or inspection of the glass, and is also preferably a waste glass generated after the glass is divided into chips and before loaded into an ion exchange chamber.

In addition, in the method of manufacturing a tempered glass of the present invention, it is preferred that, after the melting and forming of the glass batch containing a waste tempered glass are performed to provide the glass, the glass be subjected to crystallization treatment, and then the resultant crystallized glass be subjected to ion exchange treatment, to thereby provide a tempered glass.

### EXAMPLES

The present invention is hereinafter described based on Examples. The present invention is by no means limited to the following Examples.

Examples (Sample Nos. 1 to 24) of the present invention are shown in Tables 1 and 2. Sample Nos. 1 to 23 are obtained by melting and forming a glass batch containing a waste tempered glass to provide a glass, and then subjecting the resultant to ion exchange treatment. Sample No. 24 is obtained by, after melting and forming of a glass batch containing a waste tempered glass are performed to provide a glass, subjecting the glass to crystallization treatment, and then subjecting the resultant crystallized glass to ion exchange treatment. Glass compositions of the waste tempered glasses used in Examples are shown in Tables 3 and 4. Those waste tempered glasses are each a waste tempered glass recovered from a cover glass for a smartphone, an ample tube, a glass for a building material, or a cover glass for an image pickup element, which is commercially available (Sample Nos. 25 to 49).

TABLE 1

| mass % | No. 1 | No. 2 | No. 3 | No. 4 | No. 5 | No. 6 |
|---|---|---|---|---|---|---|
| SiO₂ | 61.400 | 61.300 | 61.300 | 58.400 | 66.100 | 66.910 |
| Al₂O₃ | 17.800 | 17.900 | 17.900 | 12.900 | 14.000 | 5.280 |
| B₂O₃ | 0.600 | 0.600 | 0.600 | 0.000 | 2.500 | 20.600 |
| Li₂O | 0.010 | 0.010 | 0.010 | 0.100 | 0.010 | 0.800 |
| Na₂O | 14.500 | 14.500 | 14.400 | 14.400 | 13.400 | 2.340 |
| K₂O | 2.020 | 2.050 | 2.140 | 5.640 | 0.600 | 1.590 |
| MgO | 3.050 | 3.020 | 2.980 | 1.990 | 3.000 | 0.000 |
| CaO | 0.024 | 0.078 | 0.120 | 2.030 | 0.000 | 0.550 |
| SrO | 0.000 | 0.007 | 0.014 | 0.000 | 0.000 | 0.000 |
| BaO | 0.013 | 0.017 | 0.013 | 0.014 | 0.000 | 1.140 |
| ZnO | 0.000 | 0.000 | 0.000 | 0.000 | 0.000 | 0.000 |
| Y₂O₃ | 0.000 | 0.000 | 0.000 | 0.000 | 0.000 | 0.000 |
| P₂O₅ | 0.000 | 0.000 | 0.000 | 0.000 | 0.000 | 0.000 |
| ZrO₂ | 0.001 | 0.012 | 0.017 | 4.460 | 0.000 | 0.000 |
| Sb₂O₃ | 0.000 | 0.000 | 0.000 | 0.000 | 0.000 | 0.000 |
| SnO₂ | 0.350 | 0.330 | 0.340 | 0.000 | 0.350 | 0.000 |
| Cl | 0.037 | 0.036 | 0.046 | 0.016 | 0.046 | 0.080 |
| F | 0.000 | 0.000 | 0.000 | 0.000 | 0.000 | 0.710 |
| SO₃ | 0.000 | 0.003 | 0.005 | 0.027 | 0.003 | 0.000 |
| Fe₂O₃ | 0.004 | 0.006 | 0.007 | 0.0220 | 0.0050 | 0.0005 |
| Cr | 0.00004 | 0.00006 | 0.00006 | 0.00014 | 0.00013 | 0.00004 |
| Ni | 0.00013 | 0.00008 | 0.00005 | 0.00005 | 0.00002 | 0.00008 |
| TiO₂ | 0.002 | 0.002 | 0.002 | 0.0290 | 0.0020 | 0.0005 |
| Ratio (mass %) of waste tempered | 0.1 | 50 | 80 | 98 | 77 | 15 |
| glass in glass batch | | | | | | |
| Average particle diameter D₅₀ | 30 | 5,000 | 90 | 93 | 33 | 1,000 |
| (μm) of waste tempered glass | | | | | | |
| No. of waste glass used | 25 | 25 | 25 | 26 | 27 | 28 |
| External transmittance | 92 | 92 | 92 | 92 | 92 | 92 |
| (%) at 550 nm | | | | | | |
| External transmittance | 91 | 91 | 91 | 91 | 91 | 91 |
| (%) at 400 nm | | | | | | |
| Chromaticity X | 0.3107 | 0.3104 | 0.3102 | Unmeasured | Unmeasured | Unmeasured |
| Chromaticity Y | 0.3168 | 0.3162 | 0.3165 | Unmeasured | Unmeasured | Unmeasured |
| CS (MPa) | 1,060 | 1,055 | 1,077 | 1,024 | 856 | 543 |
| DOL (μm) | 41 | 40 | 39 | 38.8 | 28 | 3 |
| mass % | No. 7 | No. 8 | No. 9 | No. 10 | No. 11 | No. 12 |
| SiO₂ | 70.800 | 69.000 | 69.000 | 66.600 | 72.200 | 64.500 |
| Al₂O₃ | 6.020 | 5.800 | 5.800 | 8.300 | 7.070 | 16.300 |
| B₂O₃ | 12.300 | 10.200 | 10.200 | 9.700 | 10.900 | 0.000 |
| Li₂O | 0.000 | 0.000 | 0.000 | 0.000 | 0.000 | 0.000 |
| Na₂O | 6.460 | 10.700 | 10.700 | 11.100 | 5.860 | 13.800 |
| K₂O | 1.120 | 0.006 | 0.005 | 0.002 | 1.950 | 0.150 |
| MgO | 0.050 | 0.000 | 0.000 | 0.000 | 0.013 | 5.100 |
| CaO | 0.750 | 3.100 | 3.100 | 3.100 | 0.720 | 0.030 |
| SrO | 0.040 | 0.000 | 0.000 | 0.000 | 0.026 | 0.000 |
| BaO | 2.140 | 0.000 | 0.000 | 0.000 | 1.190 | 0.000 |
| ZnO | 0.000 | 0.900 | 0.900 | 0.900 | 0.000 | 0.000 |
| Y₂O₃ | 0.000 | 0.000 | 0.000 | 0.000 | 0.000 | 0.000 |
| P₂O₅ | 0.000 | 0.000 | 0.000 | 0.000 | 0.000 | 0.000 |
| ZrO₂ | 0.080 | 0.000 | 0.000 | 0.000 | 0.000 | 0.070 |
| Sb₂O₃ | 0.097 | 0.000 | 0.000 | 0.000 | 0.020 | 0.000 |
| SnO₂ | 0.000 | 0.300 | 0.300 | 0.300 | 0.000 | 0.000 |
| Cl | 0.110 | 0.005 | 0.003 | 0.005 | 0.080 | 0.003 |
| F | 0.000 | 0.000 | 0.000 | 0.000 | 0.000 | 0.000 |
| SO₃ | 0.000 | 0.000 | 0.000 | 0.000 | 0.000 | 0.010 |
| Fe₂O₃ | 0.0340 | 0.0022 | 0.0004 | 0.0010 | 0.0097 | 0.0068 |
| Cr | 0.00007 | 0.00006 | 0.00001 | 0.00004 | 0.00010 | 0.00005 |
| Ni | 0.00010 | 0.00003 | 0.00001 | 0.00002 | 0.00001 | 0.00004 |
| TiO₂ | 0.0110 | 0.0010 | 0.0003 | 0.0010 | 0.0230 | 0.0140 |
| Ratio (mass %) of waste tempered | 83 | 51 | 8 | 23 | 91 | 88 |
| glass in glass batch | | | | | | |
| Average particle diameter D₅₀ | 32 | 95 | 25 | 30 | 21 | 16 |
| (μm) of waste tempered glass | | | | | | |
| No. of waste glass used | 29 | 30 | 31 | 32 | 36 | 37 |
| External transmittance | 92 | 92 | 92 | 92 | 92 | 92 |
| (%) at 550 nm | | | | | | |
| External transmittance | 91 | 91 | 91 | 91 | 91 | 91 |
| (%) at 400 nm | | | | | | |
| Chromaticity X | Unmeasured | Unmeasured | Unmeasured | Unmeasured | Unmeasured | Unmeasured |
| Chromaticity Y | Unmeasured | Unmeasured | Unmeasured | Unmeasured | Unmeasured | Unmeasured |
| CS (MPa) | 398 | 811 | 811 | 923 | 379 | 1,062 |
| DOL (μm) | 9 | 9 | 9 | 12 | 14 | 30 |

TABLE 2

| mass % | No. 13 | No. 14 | No. 15 | No. 16 | No. 17 | No. 18 |
|---|---|---|---|---|---|---|
| SiO₂ | 61.100 | 60.800 | 64.700 | 61.500 | 62.400 | 56.600 |
| Al₂O₃ | 16.800 | 16.300 | 16.500 | 19.700 | 18.100 | 24.300 |
| B₂O₃ | 0.000 | 0.600 | 0.000 | 3.900 | 0.000 | 0.000 |
| Li₂O | 0.000 | 0.000 | 0.000 | 0.000 | 4.840 | 2.810 |
| Na₂O | 15.400 | 14.100 | 14.900 | 13.200 | 5.630 | 10.000 |
| K₂O | 0.920 | 3.640 | 0.000 | 0.010 | 2.160 | 0.014 |
| MgO | 5.350 | 3.580 | 3.500 | 1.500 | 1.950 | 0.000 |
| CaO | 0.016 | 0.520 | 0.060 | 0.030 | 0.240 | 0.023 |
| SrO | 0.000 | 0.000 | 0.000 | 0.000 | 0.000 | 0.000 |
| BaO | 0.000 | 0.000 | 0.000 | 0.000 | 0.000 | 0.000 |
| ZnO | 0.000 | 0.000 | 0.000 | 0.000 | 0.000 | 1.400 |
| Y₂O₃ | 0.000 | 0.000 | 0.000 | 0.000 | 1.890 | 0.000 |
| P₂O₅ | 0.000 | 0.000 | 0.000 | 0.000 | 0.000 | 4.700 |
| ZrO₂ | 0.330 | 0.000 | 0.020 | 0.000 | 2.420 | 0.007 |
| Sb₂O₃ | 0.000 | 0.000 | 0.000 | 0.000 | 0.000 | 0.000 |
| SnO₂ | 0.000 | 0.480 | 0.360 | 0.190 | 0.000 | 0.080 |
| Cl | 0.004 | 0.012 | 0.004 | 0.015 | 0.004 | 0.011 |
| F | 0.000 | 0.000 | 0.000 | 0.000 | 0.000 | 0.000 |
| SO₃ | 0.037 | 0.003 | 0.003 | 0.002 | 0.064 | 0.001 |
| Fe₂O₃ | 0.0060 | 0.0120 | 0.0070 | 0.0110 | 0.005 | 0.009 |
| Cr | 0.00004 | 0.00015 | 0.00009 | 0.00001 | 0.00011 | 0.00009 |
| Ni | 0.00004 | 0.00009 | 0.00012 | 0.00011 | 0.00050 | 0.00003 |
| TiO₂ | 0.0047 | 0.0049 | 0.0082 | 0.0056 | 0.15 | 0.011 |
| Ratio (mass %) of waste tempered | 71 | 81 | 82 | 46 | 99.9 | 83 |
| glass in glass batch | | | | | | |
| Average particle diameter D₅₀ | 19 | 29 | 45 | 500 | 7 | 23 |
| (μm) of waste tempered glass | | | | | | |
| No. of waste glass used | 38 | 39 | 40 | 41 | 42 | 43 |
| External transmittance | 92 | 92 | 92 | 92 | 92 | 92 |
| (%) at 550 nm | | | | | | |
| External transmittance | 91 | 91 | 91 | 91 | 91 | 91 |
| (%) at 400 nm | | | | | | |
| Chromaticity X | Unmeasured | Unmeasured | Unmeasured | Unmeasured | Unmeasured | Unmeasured |
| Chromaticity Y | Unmeasured | Unmeasured | Unmeasured | Unmeasured | Unmeasured | Unmeasured |
| CS (MPa) | 1,140 | 886 | 1,068 | 980 | 970 | 993 |
| DOL (μm) | 30 | 33.8 | 33.1 | 34 | 9.8 | 26.7 |
| mass % | No. 19 | No. 20 | No. 21 | No. 22 | No. 23 | No. 24 |
| SiO₂ | 56.800 | 52.200 | 68.600 | 61.500 | 62.200 | 67.880 |
| Al₂O₃ | 25.100 | 27.500 | 4.630 | 16.600 | 17.300 | 22.280 |
| B₂O₃ | 0.000 | 0.100 | 0.000 | 0.000 | 0.000 | 0.100 |
| Li₂O | 3.640 | 3.100 | 0.000 | 0.000 | 0.000 | 3.800 |
| Na₂O | 7.460 | 7.200 | 15.600 | 12.500 | 14.900 | 0.680 |
| K₂O | 0.730 | 0.600 | 0.330 | 4.210 | 1.970 | 0.010 |
| MgO | 0.200 | 0.300 | 9.000 | 3.780 | 2.360 | 1.230 |
| CaO | 0.016 | 0.000 | 1.670 | 0.025 | 0.028 | 0.020 |
| SrO | 0.000 | 0.000 | 0.005 | 0.000 | 0.000 | 0.000 |
| BaO | 0.000 | 0.000 | 0.000 | 0.000 | 0.003 | 0.000 |
| ZnO | 0.000 | 0.000 | 0.000 | 0.000 | 0.000 | 0.000 |
| Y₂O₃ | 0.000 | 0.000 | 0.000 | 0.000 | 0.000 | 0.000 |
| P₂O₅ | 5.710 | 8.800 | 0.007 | 0.011 | 0.002 | 0.390 |
| ZrO₂ | 0.016 | 0.000 | 0.016 | 1.010 | 0.910 | 2.590 |
| Sb₂O₃ | 0.000 | 0.000 | 0.000 | 0.000 | 0.000 | 0.000 |
| SnO₂ | 0.100 | 0.100 | 0.000 | 0.220 | 0.000 | 1.180 |
| Cl | 0.004 | 0.050 | 0.030 | 0.010 | 0.009 | 0.010 |
| F | 0.000 | 0.000 | 0.000 | 0.000 | 0.000 | 0.000 |
| SO₃ | 0.001 | 0.000 | 0.200 | 0.002 | 0.001 | 0.002 |
| Fe₂O₃ | 0.048 | 0.007 | 0.013 | 0.005 | 0.006 | 0.009 |
| Cr | 0.00008 | 0.00006 | 0.00003 | 0.00001 | 0.00002 | 0.00001 |
| Ni | 0.00001 | 0.00002 | 0.00015 | 0.00013 | 0.00025 | 0.00001 |
| TiO₂ | 0.01 | 0.003 | 0.012 | 0.003 | 0.002 | 0.020 |
| Ratio (mass %) of waste tempered | 73 | 42 | 81 | 44 | 53 | 40 |
| glass in glass batch | | | | | | |
| Average particle diameter D₅₀ | 18 | 37 | 30 | 48 | 16 | 15 |
| (μm) of waste tempered glass | | | | | | |
| No. of waste glass used | 44 | 45 | 46 | 47 | 49 | 48 |
| External transmittance | 92 | 92 | 92 | 92 | 92 | 91 |
| (%) at 550 nm | | | | | | |
| External transmittance | 91 | 91 | 91 | 91 | 91 | 87 |
| (%) at 400 nm | | | | | | |
| Chromaticity X | Unmeasured | Unmeasured | Unmeasured | Unmeasured | Unmeasured | Unmeasured |
| Chromaticity Y | Unmeasured | Unmeasured | Unmeasured | Unmeasured | Unmeasured | Unmeasured |
| CS (MPa) | 1,021 | 1,094 | 781 | 921 | 1,001 | 1,174 |
| DOL (μm) | 25.7 | 24.5 | 17.6 | 40.8 | 45.2 | 7.0 |

TABLE 3

| mass % | No. 25 | No. 26 | No. 27 | No. 28 | No. 29 | No. 30 | No. 31 | No. 32 | No. 33 | No. 34 | No. 35 | No. 36 |
|---|---|---|---|---|---|---|---|---|---|---|---|---|
| SiO₂ | 61.5 | 58.4 | 66.1 | 66.9 | 70.8 | 69.0 | 69.0 | 69.0 | 69.0 | 69.0 | 66.6 | 72.2 |
| Al₂O₃ | 18.0 | 12.9 | 14.0 | 5.3 | 6.0 | 5.8 | 5.8 | 5.8 | 5.8 | 5.8 | 8.3 | 7.1 |
| B₂O₃ | 0.5 | 0.0 | 2.5 | 20.6 | 12.3 | 10.2 | 10.2 | 10.2 | 10.2 | 10.2 | 9.7 | 10.9 |
| Li₂O | 0.0 | 0.1 | 0.0 | 0.8 | 0.0 | 0.0 | 0.0 | 0.0 | 0.0 | 0.0 | 0.0 | 0.0 |
| Na₂O | 14.5 | 14.4 | 13.4 | 2.3 | 6.5 | 10.7 | 10.7 | 10.7 | 10.7 | 10.7 | 11.1 | 5.9 |
| K₂O | 2.0 | 5.6 | 0.6 | 1.6 | 1.1 | 0.0 | 0.0 | 0.0 | 0.0 | 0.0 | 0.0 | 2.0 |
| MgO | 3.0 | 2.0 | 3.0 | 0.0 | 0.1 | 0.0 | 0.0 | 0.0 | 0.0 | 0.0 | 0.0 | 0.0 |
| CaO | 0.1 | 2.0 | 0.0 | 0.6 | 0.8 | 3.1 | 3.1 | 3.1 | 3.1 | 3.1 | 3.1 | 0.7 |
| SrO | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 1.1 | 2.1 | 0.0 | 0.0 | 0.0 | 0.0 | 0.0 | 0.0 | 1.2 |
| ZnO | 0.0 | 0.0 | 0.0 | 0.0 | 0.0 | 0.9 | 0.9 | 0.9 | 0.9 | 0.9 | 0.9 | 0.0 |
| Y₂O₃ | 0.0 | 0.0 | 0.0 | 0.0 | 0.0 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 0.0 | 0.0 | 0.0 | 0.0 | 0.0 | 0.0 |
| ZrO₂ | 0.0 | 4.5 | 0.0 | 0.0 | 0.1 | 0.0 | 0.0 | 0.0 | 0.0 | 0.0 | 0.0 | 0.0 |
| Sb₂O₃ | 0.0 | 0.0 | 0.0 | 0.0 | 0.1 | 0.0 | 0.0 | 0.0 | 0.0 | 0.0 | 0.0 | 0.0 |
| SnO₂ | 0.3 | 0.0 | 0.4 | 0.0 | 0.0 | 0.3 | 0.3 | 0.3 | 0.3 | 0.3 | 0.3 | 0.0 |
| CS (MPa) | 930 | 781 | 750 | 543 | 398 | 811 | 811 | 811 | 811 | 811 | 923 | 379 |
| DOL (μm) | 46 | 48 | 33 | 3 | 9 | 9 | 9 | 9 | 9 | 9 | 12 | 14 |

TABLE 4

| mass % | No. 37 | No. 38 | No. 39 | No. 40 | No. 41 | No. 42 | No. 43 | No. 44 | No. 45 | No. 46 | No. 47 | No. 48 | No. 49 |
|---|---|---|---|---|---|---|---|---|---|---|---|---|---|
| SiO₂ | 64.5 | 61.1 | 60.8 | 64.7 | 61.5 | 64.9 | 57.9 | 57.0 | 52.2 | 68.5 | 61.7 | 67.9 | 62.5 |
| Al₂O₃ | 16.3 | 16.8 | 16.3 | 16.5 | 19.7 | 18.1 | 23.9 | 25.1 | 27.5 | 4.6 | 16.8 | 22.3 | 17.4 |
| B₂O₃ | 0.0 | 0.0 | 0.6 | 0.0 | 3.9 | 0.0 | 0.0 | 0.0 | 0.1 | 0.0 | 0.0 | 0.0 | 0.0 |
| Li₂O | 0.0 | 0.0 | 0.0 | 0.0 | 0.0 | 4.8 | 2.8 | 3.6 | 3.1 | 0.0 | 0.0 | 3.7 | 0.0 |
| Na₂O | 13.8 | 15.4 | 14.1 | 14.9 | 13.2 | 5.3 | 10.0 | 7.5 | 7.2 | 15.6 | 12.3 | 0.7 | 14.8 |
| K₂O | 0.2 | 0.9 | 3.6 | 0.0 | 0.0 | 0.2 | 0.0 | 0.7 | 0.6 | 0.3 | 4.1 | 0.0 | 2.0 |
| MgO | 5.1 | 5.4 | 3.6 | 3.5 | 1.5 | 2.0 | 0.0 | 0.2 | 0.3 | 9.0 | 3.8 | 1.3 | 2.4 |
| CaO | 0.0 | 0.0 | 0.5 | 0.1 | 0.0 | 0.2 | 0.0 | 0.0 | 0.0 | 1.7 | 0.0 | 0.0 | 0.0 |
| SrO | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 |
| Y₂O₃ | 0.0 | 0.0 | 0.0 | 0.0 | 0.0 | 1.9 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 5.2 | 5.7 | 8.8 | 0.0 | 0.0 | 0.4 | 0.0 |
| ZrO₂ | 0.1 | 0.3 | 0.0 | 0.0 | 0.0 | 2.5 | 0.0 | 0.0 | 0.0 | 0.0 | 1.0 | 2.6 | 0.9 |
| Sb₂O₃ | 0.0 | 0.0 | 0.0 | 0.0 | 0.0 | 0.0 | 0.0 | 0.0 | 0.0 | 0.0 | 0.0 | 0.0 | 0.0 |
| SnO₂ | 0.0 | 0.0 | 0.5 | 0.4 | 0.2 | 0.0 | 0.1 | 0.1 | 0.1 | 0.0 | 0.2 | 1.1 | 0.0 |
| CS (MPa) | 875 | 800 | 743 | 834 | 850 | 700 | 815 | 774 | 800 | 800 | 942 | 300 | 1,013 |
| DOL (μm) | 25 | 50 | 39 | 53 | 39 | 15 | 15 | 15 | 15 | 25 | 46 | 110 | 45 |

As described below, each sample shown in Tables 1 and 2 was produced. First, a waste tempered glass was coarsely pulverized into a size of 5 mm or less, and was then pulverized with a commercially available glass pulverization apparatus, such as a ball mill or a jet mill, so as to have a predetermined particle diameter, to thereby prepare a powdered waste tempered glass. An average particle diameter D₅₀ of each powder was measured with a commercially available laser diffraction particle size distribution analyzer or a known mesh sieve. Subsequently, a composition of the waste tempered glass after pulverization was analyzed, and then a waste glass, an oxide raw material, a nitrate raw material, and a carbonate raw material in the tables were mixed with each other so as to have a glass composition in the tables. Thus, a glass batch was produced. Next, the glass batch was melted in a continuous melting furnace, and the resultant molten glass was formed into a glass sheet. Subsequently, the resultant glass sheet was subjected to cut processing into a size of 200 mm×200 mm×0.55 mm.

Each resultant sample was evaluated for the glass composition, the transmittance, and the chromaticity.

The external transmittance is a value measured at an optical path length of 0.55 mm, and is a value measured with UV-3100PC manufactured by Shimadzu Corporation.

The chromaticity is a value calculated from a transmittance curve measured with UV-3100PC manufactured by Shimadzu Corporation in conformity with JIS Z8722:2009.

Subsequently, both surfaces of the glass sheet were subjected to optical polishing, and ion exchange treatment was performed by immersing the glass sheet in a KNO₃ molten salt at 430° C. for 4 hours. After the ion exchange treatment, the surfaces of each sample were washed.

After that, the compressive stress value (outermost surface) and the depth of layer of the compressive stress layer on the surface were calculated based on the number of interference fringes observed with a surface stress meter (FSM-6000 manufactured by Orihara Industrial Co., Ltd.) and intervals therebetween. In the calculation, the refractive index and the optical elastic constant of each sample were set to 1.50 and 30 [(nm/cm)/MPa], respectively. The compressive stress value (outermost surface) and the depth of layer of the compressive stress layer on the surface of each sample shown in Tables 3 and 4 were also calculated by the same method.

As apparent from Tables 1 and 2, each of Sample Nos. 1 to 24 has a waste tempered glass introduced into the glass batch, but the transmittance of the resultant glass sheet is high. Thus, it is conceived that recycling of the waste tempered glass can be promoted.

### INDUSTRIAL APPLICABILITY

The glass and the tempered glass of the present invention can be applied to, for example, a window glass for a vehicle, a cover glass of an interior panel for a vehicle, a cover glass for a CMOS sensor package, a cover glass for a LED package, a cover glass for a wireless communication device, a glass for a pharmaceutical container, a glass for a laboratory device, or a glass for supporting a semiconductor.

1. A glass, comprising as a glass composition, in terms of mass %, 50% to 75% of SiO₂, 1% to 30% of Al₂O₃, 0% to 25% of B₂O₃, 0% to 10% of Li₂O, 0.01% to 20% of Na₂O, 0% to 10% of K₂O, 0.0001% to 0.1% of Fe₂O₃, 0.00001% to 0.01% of Cr, 0.00001% to 0.01% of Ni, and 0.0001% to 0.5% of TiO₂.

2. The glass according to claim 1, wherein the glass comprises as the glass composition, in terms of mass %, 50% to 75% of SiO₂, 1% to 30% of Al₂O₃, 0% to 10% of B₂O₃, 0% to 10% of Li₂O, 3% to 20% of Na₂O, 0.001% to 10% of K₂O, 0% to 8% of ZrO₂, 0% to 10% of P₂O₅, 0.0001% to 0.1% of Fe₂O₃, 0.00001% to 0.01% of Cr, 0.00001% to 0.01% of Ni, and 0.0001% to 0.5% of TiO₂.

3. The glass according to claim 1, wherein the glass comprises as the glass composition, in terms of mass %, 60% to 75% of SiO₂, 1% to 15% of Al₂O₃, 1% to 25% of B₂O₃, 0% to 10% of Li₂O, 1% to 15% of Na₂O, 0.001% to 5% of K₂O, 0% to 10% of CaO, 0% to 5% of BaO, 0% to 5% of ZnO, 0.0001% to 0.1% of Fe₂O₃, 0.00001% to 0.01% of Cr, 0.00001% to 0.01% of Ni, and 0.0001% to 0.1% of TiO₂.

4. The glass according to claim 1, wherein the glass comprises as the glass composition, in terms of mass %, 65% to 75% of SiO₂, 5% to 15% of Al₂O₃, 1% to 15% of B₂O₃, 0% to 5% of Li₂O, 1% to 15% of Na₂O, 0.001% to 5% of K₂O, 0% to 10% of CaO, 0% to 5% of BaO, 0.0001% to 0.1% of Fe₂O₃, 0.00001% to 0.01% of Cr, 0.00001% to 0.01% of Ni, and 0.0001% to 0.1% of TiO₂.

5. The glass according to claim 1, wherein the glass has a content of SnO₂ of from 0 mass % to 3.0 mass % in the glass composition.

6. The glass according to claim 1, wherein the glass has a content of Cl of from 0.001 mass % to 0.3 mass % in the glass composition.

7. The glass according to claim 1, wherein the glass has a content of SO₃ of from 0 mass % to 0.3 mass % in the glass composition.

8. The glass according to claim 1, wherein the glass has a shape selected from the group consisting of a sheet shape, a tube shape, and a rod shape.

9. The glass according to claim 1, wherein the glass has an external transmittance at a wavelength of 550 nm and a thickness of 0.55 mm of 90% or more.

10. The glass according to claim 1, wherein the glass has an external transmittance at a wavelength of 400 nm and a thickness of 0.55 mm of 85% or more.

11. The glass according to claim 1, wherein the glass has a chromaticity (X,Y) in xy chromaticity coordinates (C light source, sheet thickness 1 mm conversion) within a range of (0.3090 to 0.3120, 0.3150 to 0.3180).

12. The glass according to claim 1, wherein the glass is used for any one of a window glass for a vehicle, a cover glass of an interior panel for a vehicle, a cover glass for a CMOS sensor package, a cover glass for a LED package, a cover glass for a wireless communication device, a glass for a pharmaceutical container, a glass for a laboratory device, or a glass for supporting a semiconductor.

13. A tempered glass, comprising a compressive stress layer on a surface thereof, wherein the tempered glass comprises the glass of claim 1.

14. The tempered glass according to claim 13, wherein the tempered glass has a compressive stress value of from 200 MPa to 1,500 MPa on an outermost surface thereof.

15. The tempered glass according to claim 13, wherein the compressive stress layer has a depth of layer of from 5 μm to 100 μm.

16. A method of manufacturing a tempered glass, comprising melting and forming a glass batch containing a waste tempered glass to provide a glass, and then subjecting the glass to ion exchange treatment to provide a tempered glass.

17. The method of manufacturing a tempered glass according to claim 16, wherein a ratio of the waste tempered glass in the glass batch is from 0.1 mass % to 100 mass %.

18. The method of manufacturing a tempered glass according to claim 16, wherein the waste tempered glass comprises, as a glass composition, in terms of mass %, 50% to 75% of SiO₂, 1% to 30% of Al₂O₃, 0% to 25% of B₂O₃, 0% to 10% of Li₂O, 0.01% to 20% of Na₂O, 0% to 10% of K₂O, 0% to 0.3% of Cl, and 0% to 0.3% of SO₃.

19. The method of manufacturing a tempered glass according to claim 16, wherein the waste tempered glass has a particle size D₅₀ of from 1 μm to 100 μm.

20. The method of manufacturing a tempered glass according to claim 16, the method further comprising adding, as a glass raw material, one kind or two or more kinds selected from the group consisting of an alkali metal sulfate, an alkali metal chloride, stannic oxide, and antimony trioxide into the glass batch.

21. The method of manufacturing a tempered glass according to claim 16, the method further comprising adding, as a glass raw material, a nitrate raw material into the glass batch.

22. The method of manufacturing a tempered glass according to claim 21, wherein a cation of the nitrate raw material is an alkali metal ion or an alkaline earth metal ion.

23. The method of manufacturing a tempered glass according to claim 22, wherein the alkali metal ion is one kind or two or more kinds selected from the group consisting of a lithium ion, a sodium ion, and a potassium ion.

24. The method of manufacturing a tempered glass according to claim 22, wherein the alkaline earth metal ion is a strontium ion and/or a barium ion.
